(19) United States
(12) Patent Application Publication
(10) Pub. No.: US 2024/0126870 A1
(43) Pub. Date: Apr. 18, 2024

(54) CYBER RECOVERY FORENSICS KIT - RUN AND OBSERVE OVER TIME

(71) Applicant: Dell Products L.P., Round Rock, TX (US)

(72) Inventors: Ofir Ezrielev, Beer Sheva (IL); Jehuda Shemer, Kfar Saba (IL); Amihai Savir, Newton, MA (US)

(21) Appl. No.: 18/046,798

(22) Filed: Oct. 14, 2022

(51) Int. Cl. G06F 21/55; G06F 21/56

(52) U.S. Cl. CPC G06F 21/552; G06F 21/565; G06F 2221/034

(57) ABSTRACT

A method includes accessing a group that comprises a group of PITs, replaying the PITs according to respective times at which the snapshots were taken, analyzing the PITs as they are being replayed, and based on the analyzing, identifying an event that has occurred within a time frame spanned collectively by the PITs. Replaying the PITs includes presenting the PITs, in order from oldest to newest, as a continuous stream of events.

### FIELD OF THE INVENTION

Embodiments of the present invention generally relate to the use of forensics in connection with a backup environment. More particularly, at least some embodiments of the invention relate to systems, hardware, software, computer-readable media, and methods, for the use of historical data in forensics processes.

### BACKGROUND

Typical forensics processes involve looking at the most recent available information about the state of data and/or the state of the system that generated the data. For example, a typical forensic process may consider the most recent point in time (PIT) backup, or snapshot, in attempting to determine the cause, and effects, of a problem such as malware. However, while this approach can be effective in some circumstances, it is somewhat limited in terms of its scope and, correspondingly, the insights that it can provide.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture according to an embodiment.

FIG. 2 discloses aspects of an example method according to an embodiment.

FIG. 3 discloses aspects of an example computing entity operable to perform any of the disclosed methods, processes, and operations.

### DETAILED DESCRIPTION OF SOME EXAMPLE EMBODIMENTS

Embodiments of the present invention generally relate to the use of forensics in connection with a backup environment. More particularly, at least some embodiments of the invention relate to systems, hardware, software, computer-readable media, and methods, for the use of historical data in forensics processes.

In general, example embodiments of the invention may be implemented in connection with a data protection system, one non-limiting example of which is the Dell PowerProtect Cyber Recovery system (CR). The data protection system may comprise one or more snapshots of a production system, as well as one or more snapshots of new/modified data generated by the production system. The production system may comprise, for example, one or more applications operable to generate data.

Because the data protection system may contain backups and/or snapshots, each corresponding to a particular point-in-time (PIT), the data protection system, when considered as a whole, may provide useful historical information, spanning a period of time, concerning those backups, and snapshots, the system that generated them, and the system that includes the data and applications in those backups and snapshots. Note that as used herein ‘PIT’ embraces, individually and collectively, backups and snapshots that indicate a state of a system and/or data as of a particular point in time.

Thus, an embodiment may make use of this historical information for various purposes including, but not limited to: obtain insights concerning, but not limited to, an order in which systems where infected, by tracing infections over a period of time; obtain more advanced points in time of some data systems which may allow better damage assessment as more up to date data may be identified, such as for use by insurance companies for example; examine systems that were not infected, or experienced a delayed infection, to learn what was in those systems that provided additional protection against the malware or other problem; and, obtain data to generate graphic representations of infection flows and clearer damage visualizations for use by administrators and others.

In operation, an embodiment may examine and analyze a group of PITs, which may be included as an element of a forensics kit used by an administrator, that spans a time period of interest. By presenting, and considering, the PITs in their temporal order, whether forward and/or in reverse, an embodiment may, in effect, examine a dynamic, or ‘live,’ dataset that is changing over time. Put another way, an event, or events, that have occurred in a data protection system may be replayed by an embodiment so that a user can see the evolution of the event(s) over time. Thus, an embodiment may operate so that it presents the appearance, to a user, that the data of the PITs is changing as the user observes the data.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an advantageous aspect of one embodiment of the invention is that the embodiment may operate to observe, and analyze, a dataset as the dataset changes dynamically overtime. An embodiment may present a dataset, and/or a system that generates/modifies the dataset, in such a way that the system and/or dataset appear to be ‘live’ to a user or other observer. An embodiment may provide dynamic observation and analysis of a changing system and/or changing dataset, rather than being constrained to evaluation of a particular, static, PIT. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. GENERAL ASPECTS OF AN EXAMPLE OPERATING ENVIRONMENT

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, and storage environments such as the Dell PowerProtect Cyber Recovery system (CR). In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM), containerized computing solutions, mobile devices, IoT (Internet of Things) systems and devices, edge devices and systems, and any other systems and devices, which may comprise hardware and/or software, that are capable of generating new and/or modified data.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

### B. ASPECTS OF AN EXAMPLE ARCHITECTURE

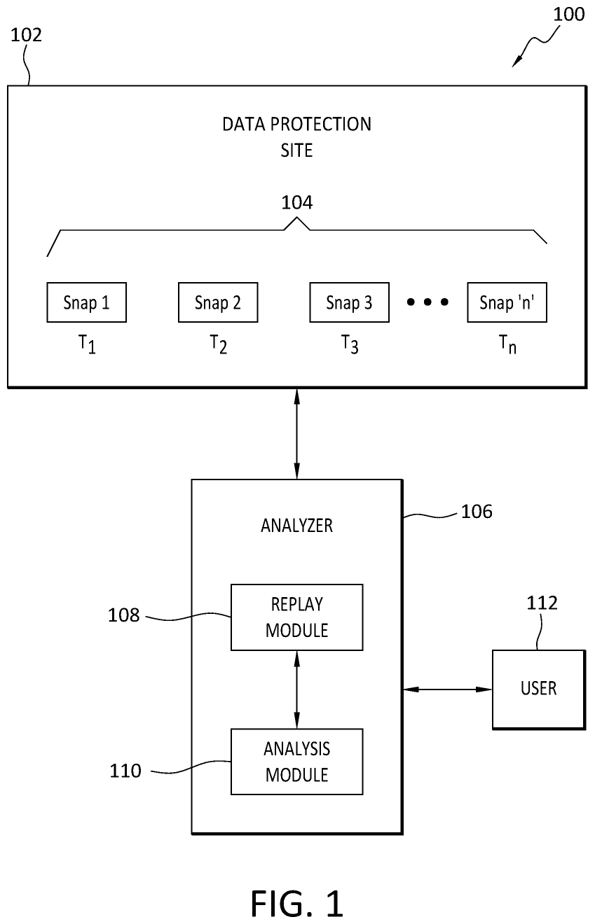

With attention now to FIG. 1, details are provided concerning an example architecture, generally denoted at 100, in connection with which some embodiments may be implemented. The information disclosed in FIG. 1 is provided only by way of illustration, and is not intended to limit the scope of the invention in any way.

As shown in FIG. 1, a data protection site 102 may be provided. In some embodiments, the data protection site 102 may comprise the Dell PowerProtect Cyber Recovery system (CR), but that is not required. The data protection site 102 may comprise one or more PITs 104, such as snapshots for example, and/or backups. The PITs may include, for example, data, and/or applications. No particular PIT content, or content implicated by a PIT, is required for any embodiment however. In general, each PIT 104 may comprise information, such as metadata for example, about the state of particular content of, or implicated by, that PIT, such as applications, data, and systems such as production systems for example, at a particular time. Accordingly, viewed individually, each PIT 104 may comprise information about the state of content and/or a system at the particular time associated with that PIT 104, but that information may provide little or no insight as to the state of that content and/or system before, or after, that PIT 104.

Thus, an embodiment may further provide for an analyzer 106 that is able to communicate with the data protection site 102 to, for example, obtain the PITs 104. The analyzer 106 may comprise a replay module 108 that is able to present the PITs 104, possibly in serial order, forward and/or reverse, according to respective PIT timestamps, to an analysis module 110 for analysis of the information included in, or implicated by, the PITs 104. The output of the analysis module 110 may be provided to a user 112. Following is a discussion of some operational aspects of some embodiments.

### C. OPERATIONAL ASPECTS OF SOME EXAMPLE EMBODIMENTS

With continued attention to the example of FIG. 1, and particularly the replay module 108, in terms of operation and effect, an embodiment of the replay module 108 may be considered as analogous to a video player that is operable to move a video forward in time, and back in time, as well as to play part or all of the video continuously. Similarly, the replay module 108 may dynamically present one or more PITs 104 in forward and/or reverse serial order to the analysis module 110 so that, from the perspective of the analysis module 110, the PITs 104 collectively depict, possibly on a continuous basis, ongoing changes to the content included in, or implicated by, the PITs.

In an embodiment, as few as two (2) PITs 104 may be adequate, although more PITs 104 may be employed, to enable a determination to be made, such as by the analysis module 110, as to the occurrence of a problem, and the nature, effects, and duration, of the problem. Thus, the analysis module 110 may receive, possibly as a stream of data, respective data/system state information for each different point in time in a series of different points in time. Note that such information may not be discerned or apparent if only a single PIT 104 were to be considered, since a single PIT 104 indicates only a system/data state at one single point in time.

In an embodiment, the analysis module 110 may control the operation of the replay module 108, although that is not necessarily required. In another embodiment, the analysis module 110 and/or the replay module 108 may be independently controlled, such as by a user 112 for example.

Finally, the output of the analysis module 110 may be provided to a user 112 that may comprise a human user and/or a computing entity. Such output may comprise, for example, the occurrence of a problem, the start/finish times of the occurrence, and the nature, effects, and duration, of the problem. The output may also comprise a graph or other depiction of the changes, over time, in one or more systems and data throughout the time period of interest. In an embodiment, the output of the analysis module 110 may comprise a prediction by the analysis module 110, based on the PITs 104 available to it, as to the flow or direction of a problem that has not yet fully run its course.

With respect to such problems, it is noted that a problem may manifest in various ways, including as a change in a system and/or data. For example, corrupted data may indicate that a problem, such as the introduction of malware, has occurred. Thus, an embodiment may operate to track the history of malware, such as the path taken by the malware within a computing system. This information may provide useful insights, such as the point of entry of the malware, and the behavior of the malware after its introduction into the system. To continue with the malware example, once it is determined that malware has been introduced, steps may be taken to ensure that a system, application, or data, as may be applicable, is not restored to a point in time that follows the malware introduction.

As another example, an embodiment may operate to track the flow of data, over time, through a system. Thus, if the data is infected, or becomes infected, a determination may be made as to the path taken by the data after the infection has occurred. This information, in turn, may facilitate an identification and assessment of systems and devices that may be adversely impacted by the infected data as that data travels the path. As this example illustrates, a compromised system may or may not be the source of a problem and in some cases, a problem may originate at a system, but in other cases the problem may originate elsewhere, but still affect the system.

### D. EXAMPLE METHODS

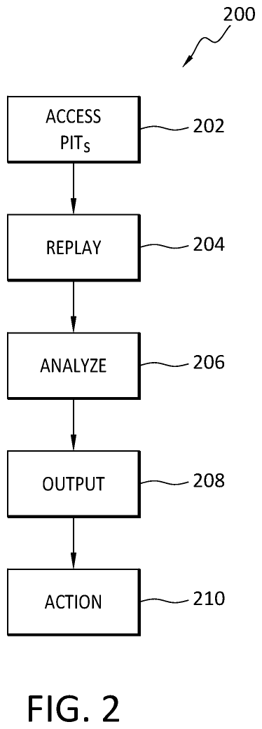

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, a method according to one example embodiment is generally denoted at 200. In an embodiment, the method 200 may be performed in whole, or in part, by an analyzer, such as the analyzer 106 disclosed herein. The analyzer may or may not be integrated into a data protection site. No particular entity, or group of entities, is necessarily required to perform the method 200, or any part of the method 200. Thus, the foregoing functional allocation is provided only by way of example and is not intended to limit the scope of the invention in any way.

The example method 200 may begin when an analyzer, for example, accesses 202 one or more PITs. The PITs may or may not be stored at a data protection site, for example. In an embodiment, one or more of the PITs may comprise, or point to, an application and/or data, and/or one or more of the PITs may comprise, or point to, a backup copy of information about the state of a computing system. The analyzer or other entity may select, based on criteria such as a start time and end time, for example, one or more of the PITs for analysis. The PIT selection criteria may be provided by a user, and/or may comprise modifiable system defaults.

Once the PITs have been selected, they may then be replayed 204, such as by a replay module for example. In an embodiment, the PITs may be replayed 204 in a sandbox or other secure site that cannot be accessed by bad actors, and which is configured to prevent any malware or other problems from escaping the sandbox.

The PITs may be replayed 204, for example, in such a way that the events contained in the PITs collectively appear, to an analysis module, as a single continuous stream of events occurring live in real time. The replay 204 may be started, and stopped, at any of the PITs, and/or between PITs. The replay 204 may be performed forward from oldest PIT to newest, or most recent, PIT. Additionally, or alternatively, the replay 204 may be performed in reverse from the most recent PIT to the oldest PIT. Thus, a replay 204 may comprise forward replay, reverse replay, or a combination of the two.

A replay 204 may involve, or inform, generation of materials, such as graphs or text files for example, that provide a record, possibly visual, of changes that have occurred over the period of time collectively spanned by the selected PITs. In an embodiment, the replay 204 may replay events only for a specified subset of the data of the selected PITs, rather than all of the data of the selected PITs. In this way, a user may obtain a granular look at a specific portion of data such as, for example, data generated by a particular application, without having to review all of the other data. Where only a subset of data is to be examined, a user, or computing entity, may provide input, such as to a replay module, identifying that subset.

During and/or after performance of the replay 204, the information of the replayed PITs may be analyzed 206. As noted herein, such ‘information’ is intended to be broadly construed and includes, but is not limited to, data, applications, system state information, and system backup information. The analysis 206 may include, but is not limited to, identifying any one or more of the following: the nature of an event; data corruption or other event affecting the integrity of data; data corruption event start/finish times, and duration; paths taken through a system or component by particular data of interest; and, systems and devices affected, or possibly affected, by an event.

After the analysis 206 has been completed, and/or while the analysis 206 is being performed, an output may be generated 208, such as by an analysis module, that indicates one or more outcomes of the analysis. The output may be provided to a human user and/or to a computing entity. Based on the output, one or more actions 210 may be taken. Such actions may include, by way of illustration, implementing system security improvements, and improving the resistance of systems and components to malware. These are provided only by way of example, and are not intended to limit the scope of the invention in any way.

### E. FURTHER DISCUSSION

As disclosed herein, an embodiment of a forensics kits may contain snapshots of parts or all of a production system, where such snapshots may include, for example, data, applications, and information about the state of the production system. Moreover, a data protection system may provide access to historical state of parts, or all, of the system. Among other things, this historical information, either alone, or in combination with information about the most recent state of the system, may provide insights for use by a forensics process. Such insights may include, but are not limited to: the order in which systems were infected, by tracing the progress of infections over time; more advanced points in time of some data systems which may enable better damage assessment as more up to date data may be identified; examination of systems that were not infected, or experienced delayed infection, to learn what was in those systems that provided additional protection against the malware or other problem; use of data to generate graphical representations of infection flows and clearer damage visualization. Thus, an embodiment may operate to analyze, over a period of time, an infected snapshot included in a forensics kit, and this analysis may be performed dynamically over a ‘live’ system, rather than simply statically as with a single PIT. This approach may, for example, provide useful insights into the operation of malware and other problems.

### F. FURTHER EXAMPLE EMBODIMENTS

Following are some further example embodiments of the invention. These are presented only by way of example and are not intended to limit the scope of the invention in any way.

Embodiment 1. A method, comprising: accessing a group that comprises a group of PITs; replaying the PITs according to respective times at which the snapshots were taken; analyzing the PITs as they are being replayed; and based on the analyzing, identifying an event that has occurred within a time frame spanned collectively by the PITs.

Embodiment 2. The method as recited in embodiment 1, wherein one or more of the PITs comprises, or points to, data.

Embodiment 3. The method as recited in any of embodiments 1-2, wherein one or more of the PITs comprises, or points to, an application.

Embodiment 4. The method as recited in any of embodiments 1-3, wherein one or more of the PITs comprises, or points to, information about a state of a computing system.

Embodiment 5. The method as recited in any of embodiments 1-4, wherein the event comprises the introduction and running of malware.

Embodiment 6. The method as recited in any of embodiments 1-5, wherein the analyzing identifies a path that infected data has taken through a computing system.

Embodiment 7. The method as recited in any of embodiments 1-6, wherein the analyzing identifies a computing system component adversely affected by an introduction of malware.

Embodiment 8. The method as recited in any of embodiments 1-7, wherein the event comprises an infection of data, and the infected data is prevented from being restored.

Embodiment 9. The method as recited in any of embodiments 1-8, wherein the event comprises a path taken by an infection resulting from an introduction of malware, and the path spans multiple PITs.

Embodiment 10. The method as recited in any of embodiments 1-9, wherein replaying the PITs comprises presenting the PITs, in order from oldest to newest, as a continuous stream of events.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

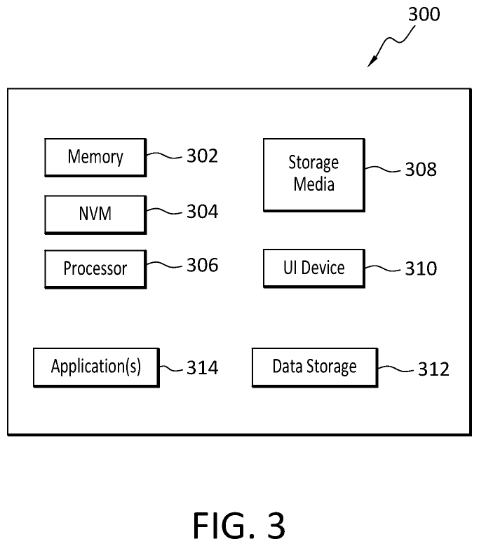

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI (user interface) device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
accessing a group that comprises a group of PITs;
replaying the PITs according to respective times at which the snapshots were taken;
analyzing the PITs as they are being replayed; and
based on the analyzing, identifying an event that has occurred within a time frame spanned collectively by the PITs.

2. The method as recited in claim 1, wherein one or more of the PITs comprises, or points to, data.

3. The method as recited in claim 1, wherein one or more of the PITs comprises, or points to, an application.

4. The method as recited in claim 1, wherein one or more of the PITs comprises, or points to, information about a state of a computing system.

5. The method as recited in claim 1, wherein the event comprises the introduction and running of malware.

6. The method as recited in claim 1, wherein the analyzing identifies a path that infected data has taken through a computing system.

7. The method as recited in claim 1, wherein the analyzing identifies a computing system component adversely affected by an introduction of malware.

8. The method as recited in claim 1, wherein the event comprises an infection of data, and the infected data is prevented from being restored.

9. The method as recited in claim 1, wherein the event comprises a path taken by an infection resulting from an introduction of malware, and the path spans multiple PITs.

10. The method as recited in claim 1, wherein replaying the PITs comprises presenting the PITs, in order from oldest to newest, as a continuous stream of events.

11. A non-transitory storage medium having stored therein instructions that are executable by one or more hardware processors to perform operations comprising:
accessing a group that comprises a group of PITs;
replaying the PITs according to respective times at which the snapshots were taken;
analyzing the PITs as they are being replayed; and
based on the analyzing, identifying an event that has occurred within a time frame spanned collectively by the PITs.

12. The non-transitory storage medium as recited in claim 11, wherein one or more of the PITs comprises, or points to, data.

13. The non-transitory storage medium as recited in claim 11, wherein one or more of the PITs comprises, or points to, an application.

14. The non-transitory storage medium as recited in claim 11, wherein one or more of the PITs comprises, or points to, information about a state of a computing system.

15. The non-transitory storage medium as recited in claim 11, wherein the event comprises the introduction and running of malware.

16. The non-transitory storage medium as recited in claim 11, wherein the analyzing identifies a path that infected data has taken through a computing system.

17. The non-transitory storage medium as recited in claim 11, wherein the analyzing identifies a computing system component adversely affected by an introduction of malware.

18. The non-transitory storage medium as recited in claim 11, wherein the event comprises an infection of data, and the infected data is prevented from being restored.

19. The non-transitory storage medium as recited in claim 11, wherein the event comprises a path taken by an infection resulting from an introduction of malware, and the path spans multiple PITs.

20. The non-transitory storage medium as recited in claim 11, wherein replaying the PITs comprises presenting the PITs, in order from oldest to newest, as a continuous stream of events.
